(19) United States
(12) Patent Application Publication
(10) Pub. No.: US 2005/0267664 A1
(43) Pub. Date: Dec. 1, 2005

(54) Method for adjusting a control signal of an electronic sensor

(76) Inventor: Jiyuan Ouyang, Windsor (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/846,817

(22) Filed: May 14, 2004

(51) Int. Cl. G06G 7/00

(52) U.S. Cl. 701/70

(57) ABSTRACT

A method of adjusting a control signal generated by a sensor (16) is provided. The control signal varies as a pedal lever (14) rotates between an idle position and a wide-open throttle (WOT) position. The method comprises comparing target values (P_{IdleT},P_{WotT}) for the control signal at the idle position and the WOT position with initial values (P_{IdleNT}, P_{WotNT}) at the idle position and the WOT position to determine if the control signal needs to be adjusted. To adjust the control signal, first (26) and second (28) trim resistors are laser trimmed. An intermediate target value (P_{IdleInt}) is determined prior to laser trimming and the first trim resistor (26) is laser trimmed until the value of the control signal at the idle position is substantially equal to the intermediate target value (P_{IdleInt}). As a result, when the second trim resistor (28) is laser trimmed, the value of the control signal at the idle position drifts to the corresponding target value (P_{IdleT}), thus eliminating the need to re-trim the first trim resistor (26).

### FIELD OF THE INVENTION

The present invention relates to a method for adjusting a control signal of an electronic sensor used in a pedal assembly. More specifically, the present invention relates to a method for adjusting the control signal of the sensor by laser trimming resistors electrically connected to the sensor.

### BACKGROUND OF THE INVENTION

Electronic sensors are used in pedal assemblies to generate a control signal that varies linearly in value as a pedal lever rotates between an idle position and a wide-open throttle position. The sensor typically comprises a main resistive track and a spaced conductive track printed on a circuit board. A sliding contact is attached to the pedal lever. The sliding contact slides along the tracks while electrically connecting the tracks when the pedal lever rotates between the idle position and the wide-open throttle position. The control signal varies linearly in value as the sliding contact slides along the tracks in accordance with well-known principles of potentiometers.

The control signal generated by the sensor is transmitted to an electronic control module (ECM) to control a vehicle system such as an electronic throttle control system. In electronic throttle control, the ECM controls a position of a throttle based on the value of the control signal that is transmitted from the sensor. Thus, as the value of the control signal varies, so does the position of the throttle. Most ECMs are programmed to recognize predetermined values for the transmitted control signal. More specifically, most ECMs are programmed to recognize a predetermined range of values for the control signal between the idle position and the wide-open throttle position. As a result, in the event that initial values of the control signal are not within the predetermined range, the control signal generated by the sensor must be adjusted prior to use to correspond to the predetermined range of values so that the throttle can be controlled appropriately.

To adjust the control signal, target values are first selected for the control signal. The target values correspond to the predetermined range of values recognized by the ECM. The target values include one target value that represents the idle position and another target value that represents the wide-open throttle position. Once these target values are selected, the initial values of the control signal are measured when the pedal lever is at the idle position and the wide-open throttle position. The initial values are then compared to the target values. Upon finding discrepancy between the values, the control signal is adjusted.

First and second trim resistors are electrically connected in series with the main resistive track to adjust the control signal. When the initial values do not substantially equal the target values, the trim resistors are laser trimmed. This involves trimming a portion of the first trim resistor while measuring the value of the control signal at the idle position until the value of the control signal at the idle position is substantially equal to its corresponding target value. The process continues by trimming a portion of the second trim resistor while measuring the value of the control signal at the wide-open throttle position until the value of the control signal at the wide-open throttle position is substantially equal to its corresponding target value. Of course, in accordance with general principles of electronic circuits, upon trimming the second trim resistor, the value of the control signal at the idle position drifts away from its corresponding target value. The first trim resistor is then trimmed again, and the process continues until the target values are substantially met. As a result, laser trimming the trim resistors is an iterative process that requires back-and-forth trimming until the target values are reached.

### BRIEF SUMMARY OF THE INVENTION AND ADVANTAGES

The present invention provides a method for adjusting a control signal generated by an electronic sensor using first and second trim resistors electrically connected to the sensor. The sensor is fitted to a pedal assembly having a pedal lever and the control signal generated by the sensor varies in value as the pedal lever rotates between an idle position and a wide-open throttle position. The method for adjusting the control signal includes selecting a target value for the control signal to be generated by the sensor when the pedal lever is at the idle position and selecting a target value for the control signal to be generated by the sensor when the pedal lever is at the wide-open throttle position. Once the target values are selected, initial values of the control signal generated by the sensor when the pedal lever is at the idle position and the wide-open throttle position are measured. The initial values are then compared to the corresponding target values. Upon finding that the corresponding values are not substantially equal, the first and second trim resistors are then trimmed until the values of the control signal at the idle position and the wide-open throttle position are substantially equal to the corresponding target values.

The method is characterized by determining an intermediate target value for the control signal based on both the target values and the initial values prior to trimming the first and second trim resistors and trimming one of the trim resistors until the value of the control signal generated by the sensor when the pedal lever is at the idle position is substantially equal to the intermediate target value.

The intermediate target value allows a manufacturer to adjust the control signal generated by the sensor between the idle position and the wide-open throttle position without any need for the back-and-forth trimming of the trim resistors of the prior art. With the method of the present invention, after one of the trim resistors is trimmed based on the intermediate target value, trimming the other trim resistor automatically shifts the value of the control signal at both the idle position and the wide-open throttle position until the values are substantially equal to the corresponding target values. In other words, the values at the idle position and the wide-open throttle position automatically drift to the corresponding target values thereby eliminating the back-and-forth laser trimming of the trim resistors.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a perspective view of a pedal assembly with an electronic sensor integrated therein;

FIG. 2 is a graph of sensor output versus pedal lever travel; and

FIG. 3 is a top view of a printed circuit board integrating the electronic sensor therein.

### DETAILED DESCRIPTION OF THE INVENTION

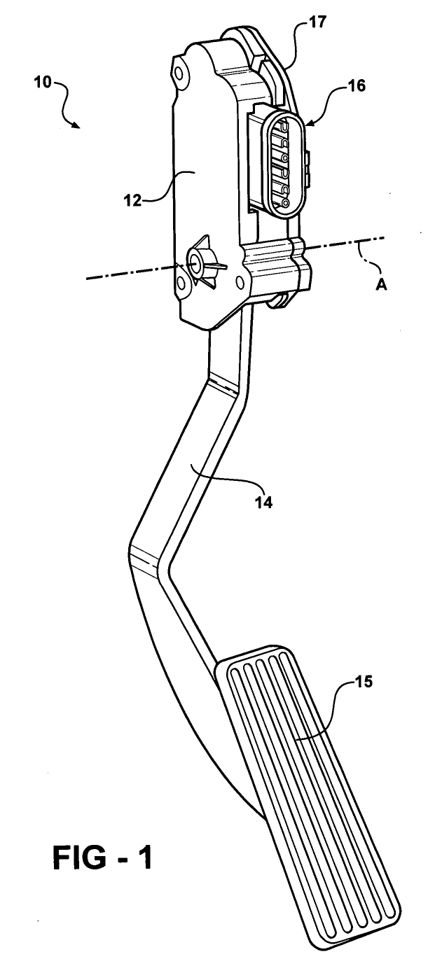

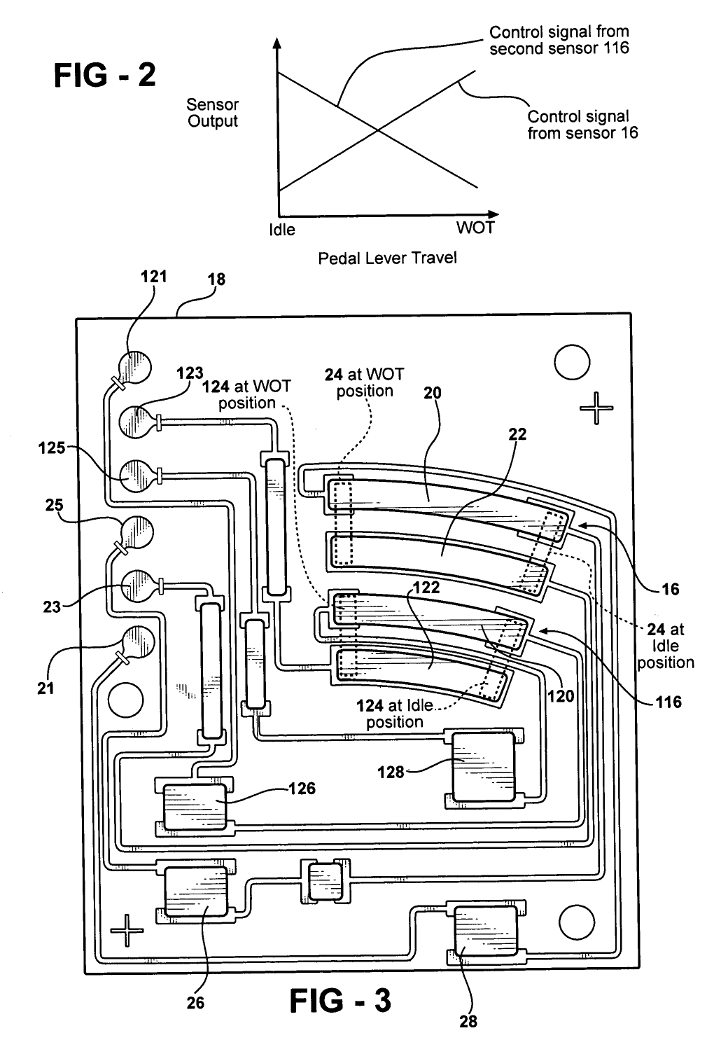

Referring to the Figures, wherein like numerals indicate like or corresponding parts throughout the several views, a pedal assembly of the present invention is generally shown at 10. With reference to FIG. 1, the pedal assembly 10 comprises a housing 12 and a pedal lever 14 pivotally supported by the housing 12. The pedal lever 14 is pivotally supported for rotation about a pivot axis A between an idle position and a wide-open throttle (WOT) position upon depression of a pedal pad 15. An electronic sensor 16 is integrated into the housing 12 of the pedal assembly 10 to generate a control signal that varies linearly in value as the pedal lever 14 rotates between the idle position and the WOT position. In FIG. 2, the control signal generated by the sensor 16 is represented as a positive slope of sensor output vs. pedal lever travel (pedal lever rotation).

Referring to FIG. 3, a cover 17 of the housing 12 has been removed to expose the sensor 16. The sensor 16 is printed on a circuit board 18 that is positioned securely within the housing 12. The sensor 16 comprises a main resistive track 20 and a conductive track 22 in spaced relation to the main resistive track 20. A sliding contact 24 (shown by dashed lines) is fixed to a first end (not shown) of the pedal lever 14. The sliding contact 24 slides along the tracks 20, 22 as the pedal lever 14 rotates between the idle position and the WOT position. The sliding contact 24 provides electrical communication between the main track 20 and the conductive track 22 to generate the control signal in accordance with well-known principles of potentiometers. In particular, a reference voltage V_{ref} is supplied to the sensor 16 at a first termninal 21 and an output voltage Vₒᵤₜ that is measured at a second terminal 23 varies as the sliding contact 24 slides along the tracks 20, 22. The sensor 16 is grounded at a third terminal 25.

First 26 and second 28 trim resistors are electrically connected to the sensor 16. The trim resistors 26, 28 are printed on the circuit board 18 in series with the main resistive track 20. The trim resistors 26, 28 are laser trimmed in accordance with the method set forth below to adjust the control signal generated by the sensor 16. The control signal may need to be adjusted for synchronizing the sensor 16 with an electronic control module (ECM) of a vehicle. Adjusting the control signal establishes a range of values for the control signal to be generated by the sensor 16 between the idle position, i.e., when the pedal lever 14 is at the idle position, and the WOT position, i.e., when the pedal lever 14 is at the WOT position.

The method for adjusting the control signal generated by the sensor 16 first comprises selecting a target range of values for the control signal to be generated by the sensor 16. The target range of values spans from one target value P_{IdleT} for the control signal to be generated by the sensor 16 at the idle position and another target value P_{WotT} for the control signal to be generated by the sensor 16 at the WOT position. These target values P_{IdleT}, P_{WotT} are equivalent to ratios of the output voltage Vₒᵤₜ relative to the reference voltage V_{ref} to be generated at the idle and WOT positions, respectively. Thus, the target values P_{IdleT}, P_{WotT} are expressed as:

$${P}_{IdleT} = \frac{{V}_{out}}{{V}_{ref}} ,$$

target ratio for the control signal at the idle position

$${P}_{WotT} = \frac{{V}_{out}}{{V}_{ref}} ,$$

target ratio for the control signal at the WOT position

Once the target values P_{IdleT}, P_{WotT} are selected, initial values P_{IdleNT}, P_{WotNT} of the control signal generated by the sensor 16 when the pedal lever 14 is at the idle position and the WOT position are measured. The initial values P_{IdleNT}, P_{WotNT} are equivalent to initial ratios of the output voltage Vₒᵤₜ relative to the reference voltage V_{ref} at the idle position and the WOT position, respectively, prior to any laser trimming. Thus, the initial values P_{IdleNT}, P_{WotNT} are expressed as:

$${P}_{IdleNT} = \frac{{V}_{out}}{{V}_{ref}} ,$$

initial ratio of the control signal at the idle position

$${P}_{WotNT} = \frac{{V}_{out}}{{V}_{ref}} ,$$

initial ratio of the control signal at the WOT position

The steps of measuring the initial values P_{IdleNT}, P_{WotNT} of the control signal when the pedal lever 14 is at the idle position and the WOT position are further defined as measuring the reference voltage V_{ref} and the output voltage Vₒᵤₜ when the pedal lever 14 is at the idle position, cycling the pedal lever 14 from the idle position to the WOT position, and measuring the reference voltage V_{ref} and the output voltage Vₒᵤₜ when the pedal lever 14 is at the WOT position.

After the initial values P_{IdIeNT}, P_{WotNT} are measured, the initial values P_{IdleNT}, P_{WotNT} are compared to the target values P_{IdleT, P}_{WotT} to determine whether the corresponding values P_{IdleNT}, P_{IdleT} and P_{WotNT}, P_{WotT} are substantially equal. In the event that the corresponding values P_{IdIeNT}, P_{IdleT} and P_{WotNT}, P_{WotT} are not substantially equal, the trim resistors 26, 28 are laser trimmed until values of the control signal at the idle position and the wide-open throttle position are substantially equal to the corresponding target values P_{IdleT}, P_{WotT}.

As a first step in the laser trimming process, an intermediate target value PIdlelnt is determined based on the target values P_{IdleT}, P_{WotT} and the initial values P_{IdleNT}, P_{WotNT}. The intermediate target value P_{IdleInt} is expressed as:

$${P}_{IdleInt} = \frac{K * {P}_{IdleT}}{1 + K * {P}_{IdleT} - {P}_{IdleNT}} where , \\ K = \frac{{P}_{WotNT} - {P}_{IdleNT}}{{P}_{WotT} - {P}_{IdleT}}$$

Once the intermediate target value P_{IdleInt} has been calculated, the first trim resistor 26 is trimmed until the value of the control signal generated by the sensor 16 when the pedal lever 14 is at the idle position is substantially equal to the intermediate target value P_{IdleInt}.

After trirruning the first trim resistor 26, the pedal lever 14 is cycled to the WOT position and the second trim resistor 28 is trimmed until the value of the control signal generated by the sensor 16 is substantially equal to the corresponding target value P_{WotT}. Trimming the second trim resistor 28 automatically shifts the value of the control signal generated by the sensor 16 when the pedal lever 14 is at the idle position to the corresponding target value P_{IdleT}. This eliminates the need for re-trimming the first trim resistor 26.

The calculation of the intermediate target value P_{IdleInt} is derived from the following relationships based on well-known principles of electrical circuits:

$${P}_{IdleNT} = \frac{{R}_{I}}{{R}_{T}} , {P}_{WotNT} = \frac{{R}_{W}}{{R}_{T}} , {P}_{IdleT} = \frac{{R}_{I}^{′}}{{R}_{T}^{′}} , {P}_{WotT} = \frac{{R}_{W}^{′}}{{R}_{T}^{′}} ,$$

and,
R_{T}=R₀+R_{IT}+R_{WT},
R′_{T}=Rᵣ+ΔR_{IT}+ΔR_{WT},
R′_{I}=R_{I}+ΔR_{IT},
R′_{W}=R_{W}+ΔR_{IT},
where,

R_{I} is the resistance at the idle position before laser trimming,

R_{W} is the resistance at the WOT position before laser trimming,

R_{T} is the total resistance of the trim resistors 26, 28 and the main resistive track 20 before laser trimming,

R₀ is the resistance of the main resistive track 20,

R′_{I}, is the resistance at the idle position after laser trimming,

R′_{W} is the resistance at the WOT position after laser trimming,

R′_{T} is to total resistance of the trim resistors 26, 28 and the main resistive track 20 after laser trimming,

ΔR_{IT} is the change in resistance of the first trim resistor 26 after laser trimming, and

ΔR_{WT} is the change in resistance of the second trim resistor 28 after laser trimming.

because,

$${P}_{IdleT} = \frac{{R}_{I}^{′}}{{R}_{T}^{′}} = \frac{{R}_{I} + Δ {R}_{IT}}{K * {R}_{T}} = \frac{1}{K} ( {P}_{IdleNT} + \frac{Δ {R}_{IT}}{{R}_{T}} ) , then , Δ {R}_{IT} = ( K * {R}_{IdleT} - {P}_{IdleNT} ) * {R}_{T} , and , K = \frac{{R}_{T}^{′}}{{R}_{T}} = \frac{{P}_{WotNT} - {P}_{IdleNT}}{{P}_{WotT} - {P}_{IdleT}} , therefore , {P}_{IdleInt} = \frac{{R}_{I}^{′}}{{R}_{T} + Δ {R}_{IT}} = \frac{{R}_{I} + Δ {R}_{IT}}{{R}_{T} + Δ {R}_{IT}} = \frac{K * {P}_{IdleT}}{1 + K * {P}_{IdleT} - {P}_{IdleNT}}$$

A second sensor 116 is also printed on the circuit board 18. The components of the second sensor 116 are illustrated in FIG. 3 with numerals adjusted by 100 relative to the corresponding components of the first sensor 16. The second sensor 116 is trimmed in accordance with the method set forth above, except that the second sensor 116 generates a negative slope of sensor output vs. pedal lever travel. See FIG. 2. As a result, the first trim resistor 126 is trimmed first until the value of the control signal at the idle position is substantially equal to the intermediate target value P_{IdleInt}, then the second trim resistor 128 is trimmed. The following equation is used to calculate the intermediate target value P_{IdleInt} used to adjust the control signal of the second sensor 116:

$${P}_{IdleInt} = \frac{{P}_{IdleNT}}{{P}_{IdleNT} + K * ( 1 - {P}_{IdleT} )} where , K = \frac{{P}_{IdleNT} - {P}_{WotNT}}{{P}_{IdleT} - {P}_{WotT}}$$

The relationships used to derive the intermediate target value P_{IdleInt} utilized in adjusting the control signal of the second sensor 116 are the same as presented above with reference to adjusting the control signal of the first sensor 16, with the following exceptions:
R′_{I}=R_{I}+ΔR_{WT}, and
R′_{W}=R_{W}+ΔR_{WT}

The method of the present invention is best illustrated by way of the following example. First, the target values P_{IdleT}, P_{WotT} are selected to establish the desired range to be generated by the control signal between the idle position and the WOT position. The target value P_{IdleT} at the idle position is an output voltage Vₒᵤₜ of 1 volt relative to a reference voltage V_{ref} of 5 volts, e.g., a target ratio of 1/5, and the target value P_{WotT} at the WOT position is an output voltage Vₒᵤₜ of 4 volts relative to a reference voltage V_{ref} of 5 volts, e.g., a target ratio of 4/5:

$${P}_{IdleT} = \frac{{V}_{out}}{{V}_{ref}} = \frac{1}{5} {P}_{WotT} = \frac{{V}_{out}}{{V}_{ref}} = \frac{4}{5}$$

With the target values P_{IdleT}, P_{WotT} selected, the initial values P_{IdleNT}, P_{WotNT} are measured. First, the pedal lever 14 is placed at the idle position to measure the initial value P_{IdleNT} of the control signal at the idle position. An output voltage Vₒᵤₜ of 0.8 volts relative to a reference voltage V_{ref} of 5 volts is measured at the idle position, e.g., an initial ratio of 0.8/5. The pedal lever 14 is then cycled to the WOT position to measure the initial value P_{WotNT} of the control signal at the WOT position. An output voltage Vₒᵤₜ of 4.1 volts relative to a reference voltage V_{ref} of 5 volts is measured at the WOT position, e.g., an initial ratio of 4.1/5:

$${P}_{IdleNT} = \frac{{V}_{out}}{{V}_{ref}} = \frac{0.8}{5} {P}_{WotNT} = \frac{{V}_{out}}{{V}_{ref}} = \frac{4.1}{5}$$

The corresponding values P_{IdleNT}, P_{IdleT} and P_{WotNT}, P_{WotT} are not substantially equal, thus the trim resistors 26, 28 must be laser trimmed until the values of the control signal at the idle position and the WOT position are substantially equal to the corresponding target values P_{IdleT}, P_{WotT}. First, however, the intermediate target value P_{IdleInt} is calculated:

$${P}_{IdleInt} = \frac{K * {P}_{IdleT}}{1 + K * {P}_{IdleT} - {P}_{IdleNT}} = \frac{3.3}{15.9}$$

$$where , \\ K = \frac{{P}_{WotNT} - {P}_{IdleNT}}{{P}_{WotT} - {P}_{IdleT}} = \frac{3.3}{3}$$

Once the intermediate target value P_{IdleInt} has been calculated, the pedal lever 14 is cycled back to the idle position and the first trim resistor 26 is trimmed until the value of the control signal at the idle position is substantially equal to the intermediate target value P_{IdleInt}. In this example, the first trim resistor 26 is trimmed until the output voltage Vₒᵤₜ measured relative to the reference voltage V_{ref} is 3.3/15.9. Assuming a constant reference voltage V_{ref} of 5 volts, this equates to an output voltage Vₒᵤₜ of approximately 1.04 volts to be set at the idle position.

After trimming the first trim resistor 26, the pedal lever 14 is cycled to the WOT position and the second trim resistor 28 is trimmed until the output voltage Vₒᵤₜ measured relative to the reference voltage V_{ref} results in the target ratio of 4/5. This automatically shifts the value of the control signal at the idle position to the corresponding target ratio of 1/5. It should be appreciated that in practice the range between the target values P_{IdleT}, P_{WotT} will generally be less than or equal to the range between the initial values P_{IdleNT}, P_{WotNT}, as illustrated in the example. In other words, the variable K will generally be greater than or equal to 1. It should also be appreciated that the method of the present invention is applied to each individual pedal assembly 10 in an assembly line to adjust the control signals generated by the sensors 16, 116 of each pedal assembly 10. Thus, the method of the present invention accounts for any mechanical variations between pedal assemblies 10 in the line that result in variations in the initial values P_{IdleNT}, P_{WotNT} of the control signals, which, for practical purposes, is often the case.

Obviously, many variations and modifications of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility.

1. A method for adjusting a control signal generated by an electronic sensor (16) using first (26) and second (28) trim resistors electrically connected to the sensor (16) wherein the sensor (16) is fitted to a pedal assembly (10) having a pedal lever (14) and the control signal generated by the sensor (16) varies in value as the pedal lever (14) rotates between an idle position and a wide-open throttle position, said method comprising the steps of:
selecting a target value (P_{IdleT}) for the control signal to be generated by the sensor (16) when the pedal lever (14) is at the idle position,
selecting a target value (P_{WotT}) for the control signal to be generated by the sensor (16) when the pedal lever (14) is at the wide-open throttle position,
measuring an initial value (P_{IdleNT}) of the control signal generated by the sensor (16) when the pedal lever (14) is at the idle position,
measuring an initial value (P_{WotNT}) of the control signal generated by the sensor (16) when the pedal lever (14) is at the wide-open throttle position,
comparing the initial values (P_{IdleNT}, P_{WotNT}) of the control signal and the corresponding target values (P_{IdleT}, P_{WotT}), and
trimming both the first (26) and second (28) trim resistors until values of the control signal at the idle position and the wide-open throttle position are substantially equal to the corresponding target values (P_{IdleT}, P_{WotT}),
said method characterized by determining an intermediate target value (P_{IdleInt}) for the control signal based on the initial (P_{IdleNT}, P_{WotNT}) and target (P_{IdleT}, P_{WotT}) values prior to trimming the first (26) and second (28) trim resistors and trimming one of the trim resistors (26, 28) until the value of the control signal generated by the sensor (16) when the pedal lever (14) is at the idle position is substantially equal to the intermediate target value (P_{IdleInt}).

2. The method as set forth in claim 1 wherein trimming one of the trim resistors (26, 28) is further defined as trinming the first trim resistor (26) until the value of the control signal generated by the sensor (16) when the pedal lever (14) is at the idle position is substantially equal to the intermediate target value (P_{IdleInt}).

3. The method as set forth in claim 2 wherein trimming both the first (26) and second (28) trim resistors further includes trinmming the second trim resistor (28) after trimming the first trim resistor (26) and until the value of the control signal generated by the sensor (16) when the pedal lever (14) is at the wide-open throttle position is substantially equal to the corresponding target value (P_{WotT}) whereby trimming the second trim resistor (28) automatically shifts the value of the control signal generated by the sensor (16) when the pedal lever (14) is at the idle position to the corresponding target value thereby eliminating any need to re-trim the first trim resistor (26).

4. The method as set forth in claim 2 wherein determining the intermediate target value (P_{IdleInt}) for the control signal is further defined as determining the intermediate target value (P_{IdleInt}) for the control signal based on the equation:
$${P}_{IdleInt} = \frac{K * {P}_{IdleT}}{1 + K * {P}_{IdleT} - {P}_{IdleNT}}$$
$$where , \\ K = \frac{{P}_{WotNT} - {P}_{IdleNT}}{{P}_{WotT} - {P}_{IdleT}}$$
and
P_{IdleInt} is the intermediate target value,
P_{IdleT} is the target value for the control signal at the idle position,
P_{WotT} is the target value for the control signal at the wide-open throttle position,
P_{IdleNT} is the initial value of the control signal at the idle position, and
P_{WotNT} is the initial value of the control signal at the wide-open throttle position.

5. The method as set forth in claim 2 wherein determining the intermediate target value (P_{IdIelnt}) for the control signal is further defined as determining the intermediate target value (P_{IdleInt}) for the control signal based on the equation:
$${P}_{IdleInt} = \frac{{P}_{IdleNT}}{{P}_{IdleNT} + K * ( 1 - {P}_{IdleT} )}$$
$$where , \\ K = \frac{{P}_{IdleNT} - {P}_{WotNT}}{{P}_{IdleT} - {P}_{WotT}}$$
and
P_{IdleInt} is the intermediate target value,
P_{IdleT} is the target value for the control signal at the idle position,
P_{WotNT} is the target value for the control signal at the wide-open throttle position,
P_{IdleNT} is the initial value of the control signal at the idle position, and
P_{WotNT} is the initial value of the control signal at the wide-open throttle position.

6. The method as set forth in claim 1 wherein the steps of selecting the target values (P_{IdleT}, P_{WotT}) for the control signal at the idle position and the wide-open throttle position are further defined as selecting target ratios based on a reference voltage (V_{ref}) and an output voltage (Vₒᵤₜ) when the pedal lever (14) is at the idle position and the wide-open throttle position.

7. The method as set forth in claim 6 wherein the steps of measuring the initial values (P_{IdleNT}, P_{WotNT}) of the control signal when the pedal lever (14) is at the idle position and the wide-open throttle position are further defmed as measuring the reference voltage (V_{ref}) and the output voltage (Vₒᵤₜ) when the pedal lever (14) is at the idle position, cycling the pedal lever (14) from the idle position to the wide-open throttle position, and measuring the reference voltage (V_{ref}) and the output voltage (Vₒᵤₜ) when the pedal lever (14) is at the wide-open throttle position.

8. The method as set forth in claim 2 including cycling the pedal lever (14) to the wide-open throttle position after trimming the first trim resistor (26).
